(19) United States
(12) Patent Application Publication
(10) Pub. No.: US 2025/0162237 A1
(43) Pub. Date: May 22, 2025

(54) METHOD FOR THE PRODUCTION OF AN EMBOSSED POLYMER FILM

(71) Applicant: OERLEMANS PACKAGING B.V., Genderen (NL)

(72) Inventors: Joan HANEGRAAF, Genderen (NL); Rogier Quirijn HERTOGH, Genderen (NL); Nick KIMMAN; Cas VEENHOVEN, Genderen (NL); Robert Cecilia Petronella VERPAALEN, Genderen (NL)

(73) Assignee: OERLEMANS PACKAGING B.V., Genderen (NL)

(21) Appl. No.: 18/837,105

(22) PCT Filed: Feb. 8, 2023
(86) PCT No.: PCT/EP2023/053137

§ 371 Date: Aug. 8, 2024

(30) Foreign Application Priority Data
Feb. 10, 2022 (NL) 2030885

(51) Int. Cl. B29C 59/02; B29C 59/00; B29C 59/04; B29K 83/00

(52) U.S. Cl. CPC B29C 59/022; B29C 59/005; B29C 59/04; B29K 2023/06; B29K 2083/00; B29K 2995/0051; B29K 2995/0072

(57) ABSTRACT

A method for the production of an embossed polymer film, more specifically an oriented polyethylene (OPE) film. An embossed polymer polyethylene film obtained via the method and use of the embossed oriented polyethylene film in an anti-slip application such as in the rubber industry.

The present invention relates to a method for the production of an embossed polymer film, more specifically an oriented polyethylene film. The present invention further relates to an embossed polymer film obtained via the method and use of the embossed polymer film in an anti-slip application.

Film embossing is a mechanical process in which a flat film is transformed into an embossed product. Embossing provides an imprint or small geometrical protrusions in the surface of the substrate, such as a foil or film. During the embossing process, thermal and stress fields are applied to the film, resulting in changes in the microstructure and physical dimensions of the material; the embossing can be done inwards (downwards) or upwards providing an upward or inward relief to the surface of the film.

Films are generally stored and transported on large rolls on which the thin films are being wrapped. Embossed films are frequently used as separation films, usually on sticky substrates such as rubber, prepreg, adhesives, tapes and composite materials, which are often stored and transported on big plastic rolls. When rolling the sticky substrates onto a roll, if no separating material is used, the substrates come into contact with each other and can no longer be processed for the end customer. The embossing of the polymer film reduces the contact surface between the film and the substrate, thereby trapping air. This makes it easy to remove the film again without damaging (tear, puncture or break) the sticky substrates. This problem of thin layers adhering to each other increases with decreasing film thickness. Embossing of such films provide increase releasing properties, however embossing also often results in loss in material properties of the thin film.

The embossing process have been designed and applied mostly for polyethylene terephthalate (PET) and polyamide (PA) based films, since these are the most common thermoplastic polymer resin of the polyester family and is used in fibres for clothing, containers for liquids and foods, etc. With environmental legislation becoming stricter and the need for a reduced carbon footprint, innovations are needed to help the industry to meet increasing demand for film materials that are more suitable for recycling, such as PE based films that is fully recyclable. A more efficient production of embossing films providing reduction in use of raw materials and reduction of waste materials during production is required.

Considering the above, there is a need in the art for a method for the production of embossing films that provides a costs and material reduction while at the same time maintains high quality and its material properties of an embossed film.

It is an object of the present invention, amongst other objects, to address the above need in the art. The object of present invention, amongst other objects, is met by the present invention as outlined in the appended claims.

Specifically, the above object, amongst other objects, is met, according to a first aspect, by the present invention by a method for the production of an embossed polymer film, comprising the steps of
a) providing an oriented polyethylene (OPE) film,
b) embossing of an embossing-pattern on said film, wherein the embossing is performed at a temperature of the foil of between 70 to 150° C., preferably 85 to 130° C., more preferably 95 to 125° C., and at an embossing pressure of between 10 to 80 N/mm, preferably 30 to 70 N/mm, more preferably 40 to 65 N/mm, and wherein the ratio of embossing depth to polymer film thickness is between 3-15 to 1, preferably between 4-12 to 1, more preferably between 5-10 to 1,
c) providing the embossed film at a production speed
d) of at least 50 m/min, preferably at least 100 m/min, more preferably at least 150 m/min.
   The method of present invention provides an embossed film comprised of a specific embossing ratio. With this embossing foil, the same embossing height can be achieved with a thinner foil, resulting in less material that can be used for the same application. Via the method of present invention, the embossed film having an extrusion thickness of 25 μm can have an embossing depth (or height) of 300 to 325 μm, which is a 50% reduction in thickness than present available PE embossed films. Experiments show that the embossing ratio obtained via the method of present invention is significantly higher with OPE embossing film when compared to the standard PE embossing film. In case the PE film having a diamond embossed pattern, when achieving an embossing depth of 135 μm, the film thickness should be at least 45 μm to obtain such an embossed film (3:1 ratio). This in contrast to an OPE film obtained via the method of present invention, wherein the embossing depth can be achieved up to 325 μm having a film thickness of only 25 μm (15:1 ratio). The embossing depth or height disclosed herein refers to the depth or height of the embossing profile on or in the polymer film. The embossing pattern is preferably protruding from one side of the polymer film; i.e. are formed as depressions on one surface of the polymer film. The method of present invention may also be used in combination with oriented polyamide (OPA), oriented polyethyleentereftalaat (OPET) or oriented polypropylene (OPP).

The thermal treatment and applied pressure to the polymer film in combination with film thickness is most significant in the embossing process to produce the embossing film of present invention. Influencing thermal treatment include the radiation heater temperature, preheat roll temperature, line velocity, and film thickness. By controlling the thermal treatment of the film, it is possible to manipulate the properties and dimensions of the embossed film; i.e. to control the embossing depth. Embossing should be done when the foil is at a temperature of 90 to 130° C. If embossing is done below 90° C., you are more likely to mechanically deform the foil which results in a lower embossing depth; i.e. outside these ranges the embossing depth cannot be achieved. If the temperature of the foil exceeds 130° C., the foil will fuse on the heat rollers, causing the foil web to break or the polymer material to burn.

Embossing of the film in general occurs using a machine with two or more rolls whose surfaces are forced against each other to apply a force to the film going between the rolls. For the specific pressure applied during embossing of the OPE film; a pressure that is too low results in an embossing depth that is too low or even no embossing depth. Too high a pressure results in high machine loading, causing wear or even destruction of the polymer film and also of the machine parts. The embossing pressure of 10 to 80 N/mm is comparable to an applied pressure on the film of between 20 to 60 bar having a film width of 1900 mm.

The method of present invention enable the production of much thinner embossed PE films while at the same time maintaining the release properties of the film material. The embossing film of present invention provides a costs/material reduction of about 25% in relation to the state of the art foils. The foils are thinner, have less tendency to adhere to each other and provide an improved release effect due to the embossing pattern in combination with the film and embossing depth ratio. The embossing film of present inventions has improved material properties in view of heat resistance, improved storage capabilities at low temperatures (i.e. below 0° C.), especially the OPE film showed improved resistance in comparison to BOPE film to shrinkage after being heated to at least 90° C. for embossing, thereby preventing mutually adherence of multiple films to each other at the edges of the embossing films (for example when stored as prepreg of resin-impregnated fibres), the surface of the film has improved tendency to remain ply and wrinkle-free. Furthermore, the method of present invention can replace current embossed films including PET or PA films in view of the much more efficient recyclable PE.

According to a preferred embodiment, the present invention relates to the method for the production of an embossed polymer film, wherein the embossing depth is between 50 to 500 μm, preferably 100 to 325 μm, more preferably 125 to 250 μm, most preferably 135 to 180 μm. To ensure the function as an air duct in packaging using the embossed film, the embossing depth must be at least more than 50 μm. If embossing depth is below 50 μm, there will be an insufficient release of the polymer material; insufficient releasability which can lead to adhesion to the product of the customer when the OPE film is being used as release liner for example. If embossing depth is above 500 μm the releasability is too high, causing the film to come loose during production (from the production line) leading to production time outs, and also unsuitable as a release liner by the end user.

According to another preferred embodiment, the present invention relates to the method for the production of an embossed polymer film wherein the polymer film has a thickness of between 20 to 200 μm, preferably 25 to 150 μm, more preferably 30 to 100 μm, most preferably 35 to 80 m.

According to yet another preferred embodiment, the present invention relates to the method for the production of an embossed polymer film, wherein the embossing pattern is selected from the group consisting of pyramid, diamond, shark skin, lotus flower, satin, and linen, preferably pyramid or lotus flower. Embossed films are widely used as separating films on mostly sticky substrates. Due to the applied embossing, the contact surface between film and substrate is reduced and air is enclosed. This makes the film easy to remove again after being stored on a roll for example. The satin embossing pattern is a fine embossing consisting of very small squares aligned with each other, comparable to a satin fabric. The linen embossing pattern comprises a wave motif wherein the waves are close to each other or overlap such that two waves can form circles, comparable to the linin fabric. The pyramid and diamond embossing pattern are comprised of small pyramid and diamond shaped embossed into the OPE film. Experiment show that film embossed with the pyramid outperform the diamond shape embossed film in terms of releasability and storage capabilities. The thickness of the film in combination with the selection of specific embossing pattern and embossing depth may result in too much air being trapped within the separate film layer when storing the film onto a storage roll, resulting in wrinkling of the (side) of the film. Furthermore, the pyramid embossed film (in contrast to the diamond pattern) showed to remain ply and wrinkle-free during the application (roll up) of the film onto a rubber storage roll. The shark skin and lotus flower embossing pattern resemble their natural occurrence, i.e. the surface of a shark skin and the leaf surface of a lotus flower, respectively. Both shark skin and lotus flower embossing pattern provide the so-called lotus effect providing self-cleaning or repellent properties to the surface of the embossed film as a result of the embossed pattern. Due to the microscopic architecture on the surface of these specific embossing pattern, dust and fluid adhesion (such a small droplets) to the surface of the embossed film is minimized or prevented.

According to a preferred embodiment, the present invention relates to the method for the production of an embossed polymer film wherein said embossing-pattern is pyramid and the ratio of embossing depth to film thickness is between 8-12 to 1, preferably 10 to 1.

According to a preferred embodiment, the present invention relates to the method for the production of an embossed polymer film wherein said embossing-pattern is diamond and the ratio of embossing depth to film thickness is between 3-6 to 1, preferably 4 to 1.

According to a preferred embodiment, the present invention relates to the method for the production of an embossed polymer film wherein the OPE film is comprised of one or more selected from the group consisting of LDPE, LLDPE, MDPE, HDPE, mLLDPE, and plastomers, or mixtures thereof.

According to a preferred embodiment, the present invention relates to the method for the production of an embossed polymer film wherein the oriented polyethylene film has been oriented in machine direction (MD) only. The embossed OPE film may be a bi-axially oriented high-density polyethylene (BOPE) films, or oriented high-density polyethylene (OPE) films. Furthermore, the film orientation in machine provided significant improvements to the final properties of the embossed film, especially in view of shrinkage and releasability properties. Therefore, preferably the OPE film is an only in machine direction (MD) oriented OPE films.

The present invention, according to a second aspect, relates to an embossed polymer film obtainable via the method of present invention, wherein the ratio of embossing depth to polymer film thickness is between 3-15 to 1, preferably between 4-12 to 1, more preferably between 5-10 to 1, wherein the polymer film is selected from oriented polyethylene (OPE), oriented polyamide (OPA), or oriented polyethyleentereftalaat (OPET) film, oriented polypropylene (OPP), preferably OPE film.

According to a preferred embodiment, the present invention relates to the embossed polymer film wherein said film is oriented in machine direction only.

According to another preferred embodiment, the present invention relates to the embossed polymer film, wherein the film has a thickness of between 20 to 200 μm, preferably 25 to 150 μm, more preferably 30 to 100 μm, most preferably 35 to 80 μm.

According to yet another preferred embodiment, the present invention relates to the embossed polymer film, wherein the embossing depth is between 50 to 500 μm, preferably 100 to 300 μm, more preferably 125 to 225 μm.

According to a preferred embodiment, the present invention relates to the embossed polymer film wherein said film comprises a pyramid embossing-pattern and wherein the ratio of embossing depth to film thickness is between 8-12 to 1, preferably 10 to 1.

According to a preferred embodiment, the present invention relates to the embossed polymer film wherein said film further comprises 0.1 to 15 wt % of a siloxane polymer, preferably diorganopolysiloxane. The inclusion of a siloxane polymer in the polymer film functions as a release agent and providing improved release and enhanced demolding capabilities of the embossed polymer film.

The present invention, according to a further aspect, relates to the use of an embossed polymer film of the present invention in an anti-slip application selected from the group consisting of carrier bags, aviation, pre-preg industry, pallet sheets, plastic consumer bags, diaper bags, or release liner, preferably as release liner.

The present invention will be further detailed in the following examples and figures wherein:

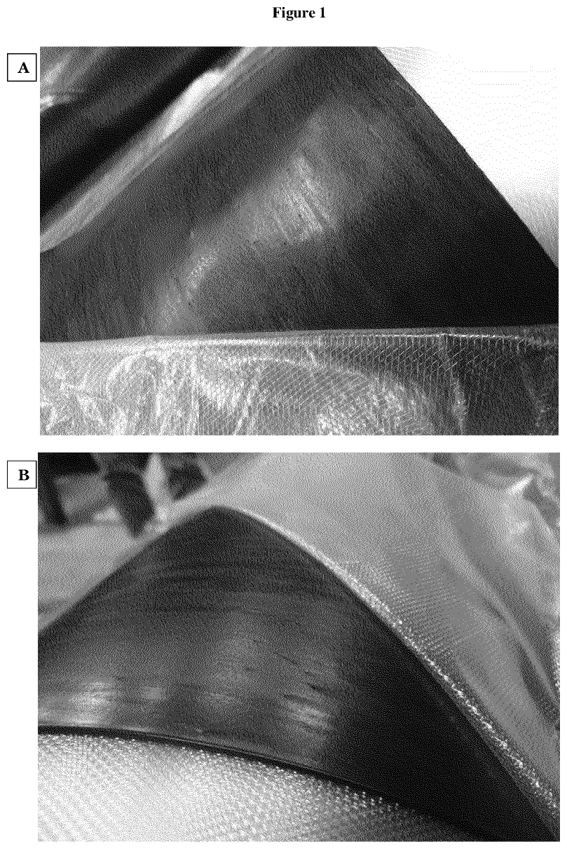

FIG. 1: shows the surface of the rubber roll that has been wrapped with embossed film that was produced according to the method of present invention. The rubber surface of the roll is shown after the embossing foil has been released completely. FIG. 1A shows the film comprised of diamond embossing and FIG. 1B shows the film comprised of pyramid embossing. The diamond embossing imprint remains in the rubber surface indicating a level or tendency of adherence of the embossed film to the surface. For the pyramid embossing film, the imprints on the rubber surface is less pronounced, therefore the properties in view of releasability of the embossed film comprised of the pyramid pattern is higher.

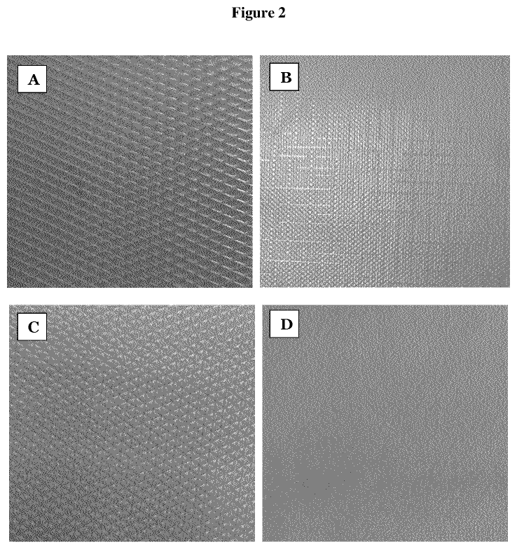

FIG. 2: shows examples of the embossing pattern of an OPE film of present invention; A=diamond, B=linen, C=pyramid, D=satin.

### EXAMPLES

### Example 1—Production and Testing of Embossed Films as Release Liner

According to the method of present invention an embossed film was produced and tested as release liner on a rubber roll comprising 650 μm of embossed OPE film. The OPE film was produced at 150 m/min at an embossing pressure of 60 N/mm and a temperature of 100° C., and provided with a pyramid embossing pattern. The film has an average thickness of 25 μm and comprised an embossing depth of on average 270 μm (varying embossing depth from 254 to 286 m). During production of the embossed film no signs of wrinkling of the film were observed and releasability of the film was scored as very good.

In a further test in view of production speed three embossing films provided with a diamond embossing pattern at an embossing pressure of 80 N/mm, the film has an average thickness of 25 μm; films A to D were produced;
A) at 50 m/min and a temperature of 80° C. The film comprised an embossing depth of about 50 μm, which was too low in view of proper releasability of the film. Also the roll up of the film onto the roll was not sufficient, resulting in wrinkling and ply formation of the film.

B) at 50 m/min and a temperature of 125° C. and comprised an embossing depth of on average 124 μm (varying embossing depth from 119 to 129 μm). During production of the embossed film no signs of wrinkling of the film were observed. The film was sufficiently releasable.
C) at 100 m/min and a temperature of 131° C. and comprised an embossing depth of on average 100 μm (varying embossing depth from 98 to 105 μm). During production of the embossed film no signs of wrinkling of the film were observed. The film was sufficiently releasable.
D) at 150 m/min and a temperature of 131° C. The film comprised an embossing depth of on average 108 μm (varying embossing depth from 104 to 116 μm). During production of the embossed film no signs of wrinkling of the film were observed. The film was sufficiently releasable. However slight trembling of the film on the production line was observed which may result at even higher speeds, i.e. above 150 m/min, wrinkling or ply formation of the film.

### Example 2—OPE Embossed Film

Embossing films produced according to the method of present invention comprised of a diamond embossing pattern (ratio about 5:1) were compared to embossing films comprised of a pyramid pattern (about 11:1) and were tested for their releasability, after being stored onto a roll after production according to the method of present invention. Embossing films were directly wrapped/rolled onto a roll after production.

Roll up of the OPE films onto the roll was smoother with the embossing film comprised of a pyramid pattern in contrast to the diamond pattern. The surface of the rubber roll that has been wrapped with embossed film that was produced according to the method of present invention was investigated. The rubber surface of the roll is shown after the embossing foil has been released completely. FIG. 1A shows the film comprised of diamond embossing and FIG. 1B shows the film comprised of pyramid embossing. As shown in FIGS. 1A and 1B, the releasability of the pyramid pattern embossed film showed a slight improved releasability, although for both films releasability was sufficient in the sense that no breakage, puncture or tearing of the film occurred. The diamond embossing imprint remains in the rubber surface indicating a level or tendency of adherence of the embossed film to the surface. For the pyramid embossing film, the imprints on the rubber surface is less pronounced, therefore the properties in view of releasability of the embossed film comprised of the pyramid pattern is higher.

Furthermore, embossing films produced via the method of present invention are produced much thinner than the known embossing films available in the market; previously 750 meter of film could be stored onto a roll, the embossing film produced according to the method of present invention enables to store more than 1000 meter, even 1.500 meter onto a single roll. This also results in less downtime and less waste for end users when using these 1000+ meter embossing films on a single roll, when producing products comprising the embossing film.

### Example 3—OPE Embossed Film Versus PE Embossed Film

Embossed OPE films produced via the method of present invention, comprised of a diamond or pyramid embossing pattern were compared to standard PE embossing films. Experiments were done to investigate the maximum embossing depth (Table 1) and minimum film thickness (Table 2) in view of the OPE and PE embossed films.

TABLE 1
Maximum embossing depth in relation to film thickness.

| | | ^{A} Emb. depth | ^{B} Thickness film | |
|---|---|---|---|---|
| | Emb. Pattern | (μm) | (μm) | Ratio A/B |
| PE | Diamond | 65 | 25 | 2.6 |
| | Pyramid | 150 | 35 | 4.3 |
| OPE | Diamond | 125 | 25 | 5 |
| | Pyramid | 325 | 25 | 15 |

TABLE 2
Minimum film thickness in relation to embossing depth.

| | | ^{A} Emb. depth | ^{B} Thickness film | |
|---|---|---|---|---|
| | Emb. Pattern | (μm) | (μm) | Ratio A/B |
| PE | Diamond | 110 | 40 | 2.75 |
| | Diamond | 135 | 45 | 3 |
| | Pyramid | 320 | 62 | 5.2 |
| | Pyramid | 330 | 80 | 4.1 |

The embossing ratio is significantly higher with OPE embossing film when compared to the standard PE embossing film. For example in case the PE film having a diamond embossed pattern, when achieving an embossing depth of 135 μm, the film thickness should be at least 45 m to obtain such an embossed film (3:1 ratio). This in contrast to an OPE film obtained via the method of present invention, wherein the embossing depth can be achieved up to 325 μm having a film thickness of only 25 μm (15:1 ratio). Furthermore, additional tests have been done with PE films and OPE film of present invention in combination with satin and linen embossing patterns. The embossing ratio (depth embossing/film thickness) for the PE films and satin was between 1.3 and 3.3, and for linen between 1.3 and 2.7.

1. A method for the production of an embossed polymer film, comprising the steps of:
a) providing an oriented polyethylene (OPE) film,
b) embossing of an embossing-pattern on said film, wherein the embossing is performed at a temperature of the foil of between 70 to 150° C., and at an embossing pressure of between 10 to 80 N/mm, and wherein the ratio of embossing depth to polymer film thickness is between 3-15 to 1, and
c) providing the embossed film at a production speed of at least 50 m/min.

2. The method according to claim 1, wherein the embossing depth is between 50 to 500 μm.

3. The method according to claim 1, wherein the OPE film has a thickness of between 20 to 200 μm.

4. The method according to claim 1, wherein the embossing pattern is selected from the group consisting of pyramid, diamond, shark skin, lotus flower, satin, and linen.

5. The method according to claim 1, wherein said embossing-pattern is pyramid and the ratio of embossing depth to film thickness is between 8-12 to 1.

6. The method according to claim 1, wherein said embossing-pattern is diamond and the ratio of embossing depth to film thickness is between 3-6 to 1.

7. The method according to claim 1, wherein the OPE film is comprised of one or more selected from the group consisting of LDPE, LLDPE, MDPE, HDPE mLLDPE, and plastomers, or mixtures thereof.

8. The method according to claim 1, wherein the oriented polyethylene film has been oriented in machine direction (MD) only.

9. An embossed polymer film obtainable via the method of claim 1, wherein the ratio of embossing depth to polymer film thickness is between 3-15 to 1, wherein the polymer film is an oriented polyethylene (OPE) film.

10. The embossed polymer film according to claim 9, wherein said film is oriented in machine direction only.

11. The embossed polymer film according to claim 9, wherein the film has a thickness of between 20 to 200 μm.

12. The embossed polymer film according to claim 9, wherein the embossing depth is between 50 to 500 μm.

13. The embossed polymer film according to claim 9, wherein said film comprises a pyramid embossing-pattern and wherein the ratio of embossing depth to film thickness is between 8-12 to 1.

14. The embossed polymer film according to claim 9, wherein said film further comprises 0.1 to 15 wt % of a siloxane polymer.

15. A use of the embossed polymer film of claim 9 in an anti-slip application selected from the group consisting of carrier bags, aviation, pre-preg industry, pallet sheets, plastic consumer bags, diaper bags, or release liner.
